(19) United States
(12) Patent Application Publication
(10) Pub. No.: US 2014/0053738 A1
(43) Pub. Date: Feb. 27, 2014

(54) Slow Cooking Appliance with Latching Arrangement

(71) Applicant: Sunbeam Products, Inc., Boca Raton, FL (US)

(72) Inventors: Larry Randall, Coral Springs, FL (US); Adam Day, Boynton Beach, FL (US)

(73) Assignee: Sunbeam Products, Inc., Boca Raton, FL (US)

(21) Appl. No.: 13/884,388

(22) PCT Filed: Jan. 10, 2013
(86) PCT No.: PCT/US13/21047

§ 371 Date: May 9, 2013

Related U.S. Application Data
(60) Provisional application No. 61/585,897, filed on Jan. 12, 2012.

(51) Int. Cl. A47J 27/00

(52) U.S. Cl. CPC A47J 27/004
USPC 99/324

(57) ABSTRACT

A slow cooker appliance includes a lid, cooking vessel, housing and at least one but preferably two latching arrangements for securing the lid. Each latching arrangement includes a lid mount mounted on opposing sides of the periphery of the lid, a U-shaped member pivotally attached to the lid mount, and a rotating member rotatably connected to a housing mount disposed on a sidewall of the slow cooker housing, A U-shaped member is looped around the rotating member and a cammed surface on the rotating member urges against the end of the U-shaped member as the rotating member is rotated clockwise or counter-clockwise from an unlatched position to one of two possible latched positions. This creates a force in the U-shaped member that is transmitted to the lid mount. The lid mount urges the lid against a rim of the cooking vessel thereby securing the lid and the container to the housing.

### FIELD OF THE INVENTION

The invention relates to slow cookers; and more particularly, to a slow cooker having a latching arrangement for securing the lid to the slow cooker and allowing transport of the slow cooker.

### BACKGROUND OF THE INVENTION

Slow cooking appliances are known in the art. Typically, slow cookers include a lid, cooking vessel, heating element and controls, housing, and a recess in the housing for receiving the cooking vessel. In operation, the cooking vessel is inserted into the recess, food contents to be heated are placed into the cooking vessel, and the lid is placed onto the rim of the cooking vessel. Electronic controls are used to turn on the heating element for a desired time to cook and/or warm the food. One problem with such slow cookers is that when transporting the slow cooker the lid may slip off of the rim of the cooking vessel and food contents therein may spill.

### SUMMARY OF THE INVENTION

In an embodiment of the invention, there is provided a cooking appliance including a container including an interior volume and an opening into the interior volume wherein food contents to be heated is accessed, the container including a rim defining the opening, a housing having a recess for receiving the container, a heating element proximate the recess for heating the container when seated in the recess, a lid sized and shaped to fit over the opening and having a periphery that is seated on the rim when the lid is placed over the opening of the container, and at least one latching arrangement disposed on the periphery of the lid configured to secure the lid to the container and the housing when the container is seated in the recess. The latching arrangement includes a lid mount mounted on the periphery of the lid, a U-shaped member pivotally attached to the lid mount, a rotating member mounted on the housing and rotatable clockwise or counter-clockwise between an unlatched position and one of two latched positions. An end of the U-shaped member is looped around the rotating member when the rotating member is in the unlatched position, and as the rotating-member is rotated in either of the clockwise or counter-clockwise directions to one of the latched positions, a cammed surface of the rotating member urges against the end of the U-shaped member which creates a force in the U-shaped member that is transmitted to the lid mount on the lid causing the lid mount to urge the lid against the rim of the container and secure the lid to the container and the housing.

In an embodiment of the invention, there is provided a slow cooker appliance including a lid having a periphery, a cooking vessel having an opening wherein food contents to be heated is inserted and a rim wherein the periphery of the lid is seated when, the lid is placed over the opening of the cooking vessel, a housing having a recess for receiving the cooking vessel, a pair of opposing latching arrangements disposed about a periphery of the lid for securing the lid to the cooking vessel and the housing when the cooking vessel is seated in the recess. Each latch arrangement includes a lid mount mounted on opposing sides on the periphery of the lid, a U-shaped member pivotally attached to the lid mount, and a rotating member rotatably connected to a housing mount disposed on a sidewall of the housing and rotatable clockwise or counter-clockwise between an unlatched position and a latched position. The U-shaped member is pivoted such that an end of the U-shaped member is looped around the rotating member when the rotating member is in the unlatched position, and as the rotating member is rotated in either of the clockwise or counter-clockwise directions to the latched position, a rammed surface of the rotating member urges against the end of the U-shaped member which creates a force in the U-shaped member that is transmitted to the lid mount on the lid causing the lid mount to urge the lid against the rim of the cooking vessel and secure the lid and the cooking vessel to the housing.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front perspective view of a slow cooking appliance utilizing an embodiment of a latching arrangement for securing a lid to the slow cooker in a latched or first configuration;

FIG. 2 is a right side view thereof;

FIGS. 3A-3C are various cutaway exploded perspective views of the latching arrangement and slow cooker of FIG. 1 in an unlatched or second configuration; and

FIGS. 4A-4D are front perspective views of the slow cooker of FIG. 1 illustrating the stages of securing the lid to the slow cooker using the latching arrangement from the second or unlatched configuration to the first or ladled configuration.

### DETAILED DESCRIPTION OF THE INVENTION

A slow cooker appliance such as that disclosed in but not limited to the slow cookers disclosed in U.S. Pat. Nos. 6,740,855, 6,740,855, 7,312,425 and 6,587,739, all of which are incorporated by reference in their entirety as if fully rewritten herein, having a latching arrangement for securing the lid to the cooking vessel and housing of the slow cooker through the use of a gasket to ensure a watertight seal, including the embodiment of a latching arrangement as illustrated in the Figures and the detailed description below.

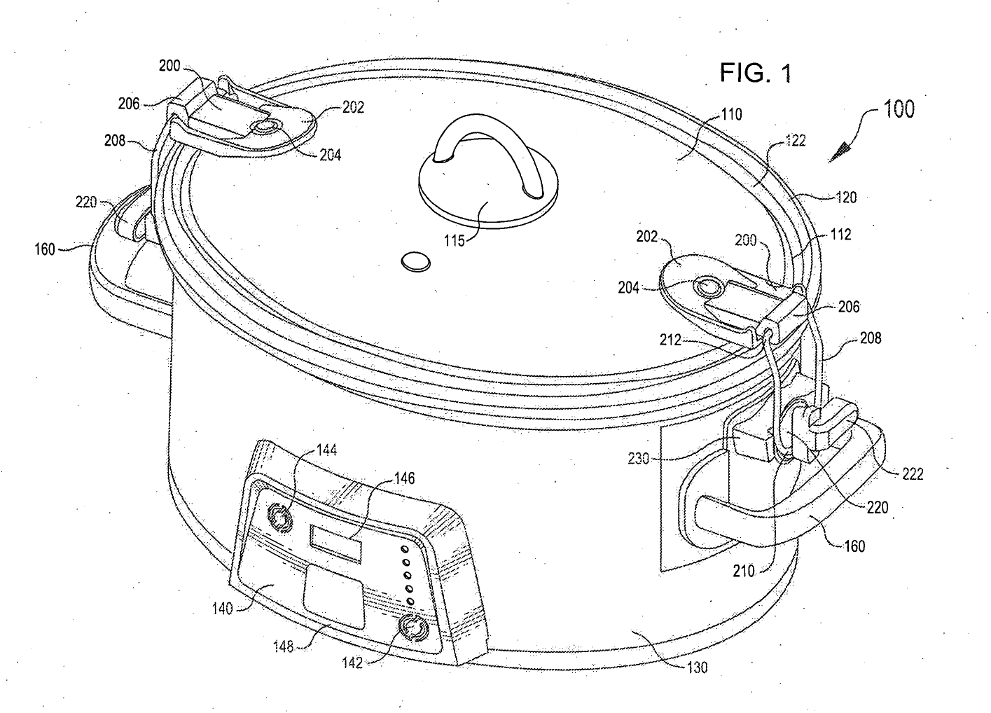

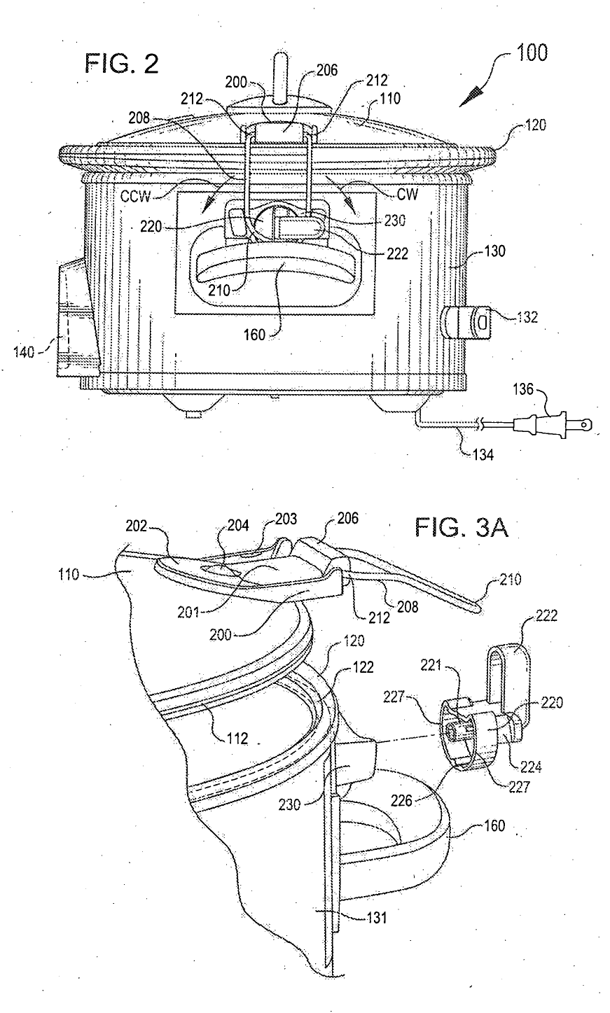

Referring to FIGS. 1-2, shown is an exemplary slow cooker 100 having an embodiment of a latching arrangement 200 for securing a lid 110 to a housing 130 in a fluid-tight manner so that food does not spill from within a cooking vessel 120 while the slow cooker 100 is being transported. In addition to the foregoing components, the slow cooker 100 may include a heating element (not shown), a control panel 140 including electronic controls 142, 144 for controlling the heating element (not shown) and displays 146, 148 for indicating characteristics related to slow cooking including but not limited to cooking time, temperature, etc., a recess (not shown) in the housing 130 for receiving the cooking vessel 120, and a pair of handles 160 mounted oppositely on the housing 130 for transporting the slow cooker 100. It should be understood that this is only one possible embodiment of a latching arrangement and not meant to be limiting as other embodiments of a latching arrangement are possible with the same and/or similar components.

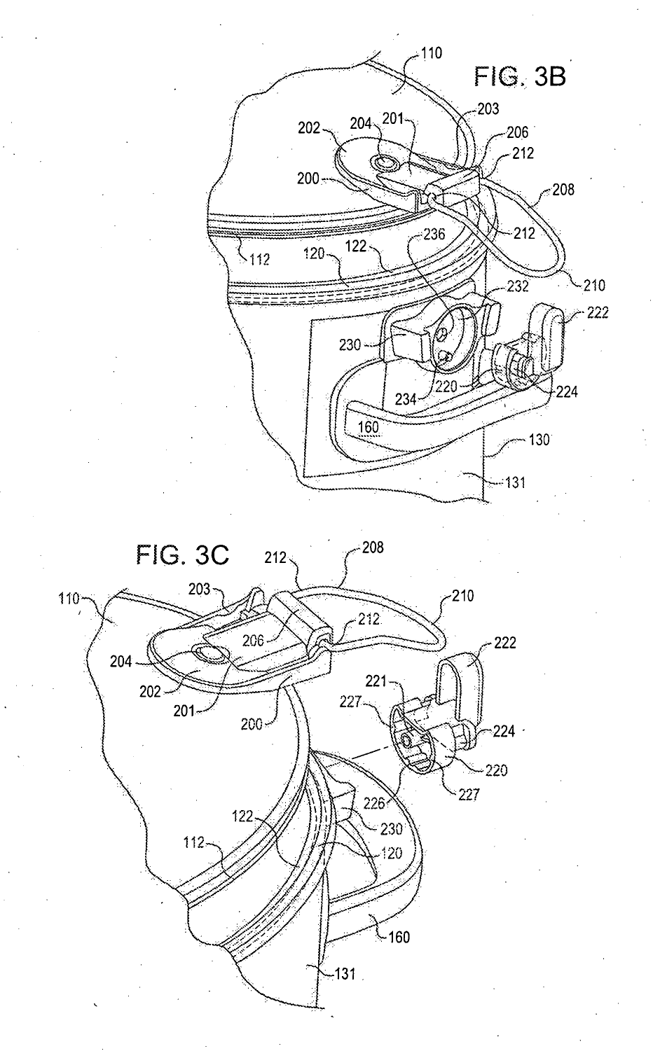

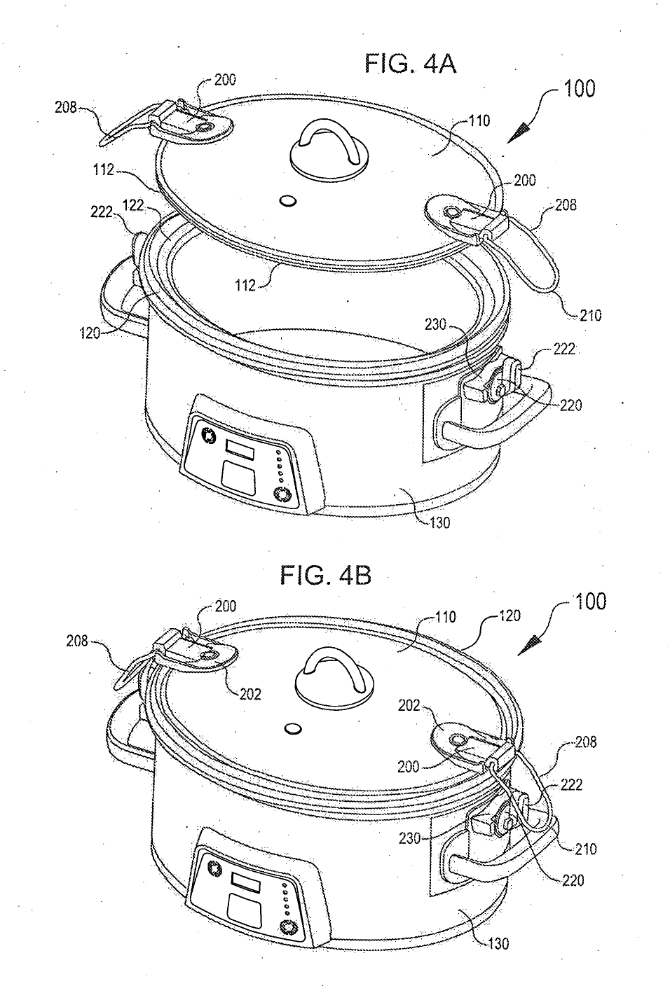

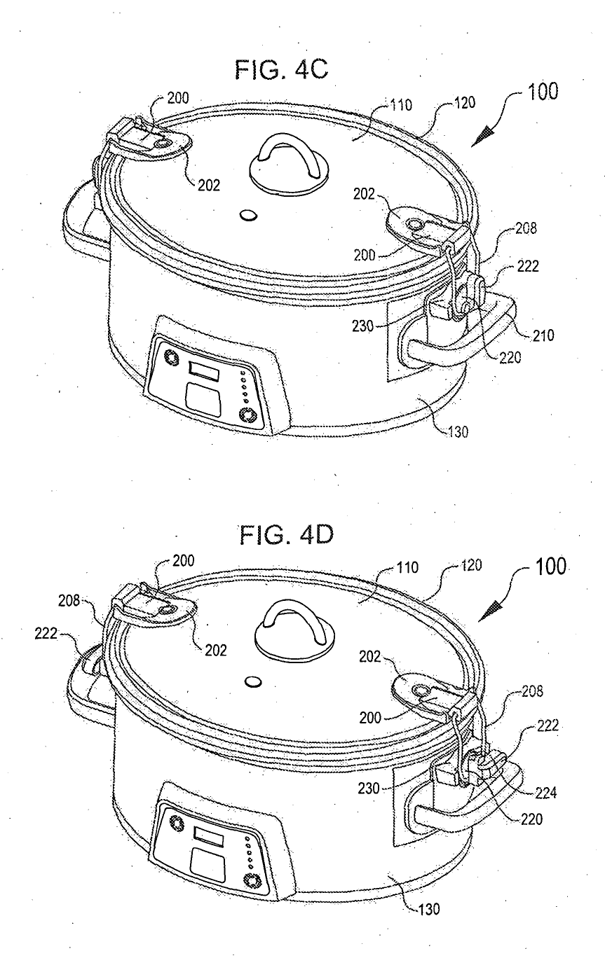

In an embodiment, two latching arrangements 200 are disposed on opposing sides of the lid 110 and housing 130. A gasket 112 on the periphery of the lid 110 is positioned beneath the lid 110 and a lip or rim 122 on an upper edge of the cooking vessel 120 disposed in the recess (not shown) in the housing 130. The cooking vessel 120 has an open top and an interior volume where food contents may be inserted and accessed. The lid 110 is sized and shaped to fit over the open top and have its periphery seated into the rim 122. In an embodiment, the cooking vessel 120 is a conventional stoneware cooking vessel comprised of ceramic materials but this is not meant to be limiting. In a first configuration, the latching arrangements 200 are moved in the direction of either of arrows CW (clockwise direction) or CCW (counter-clockwise direction) to one of the fully latched positions as shown in FIG. 1 (see also FIGS. 2 and 4D), and the gasket 112 is compressed between the lid 110 and the rim 122 of the cooking vessel 120. This locks the cooking vessel 120 into the recess (not shown) in the housing 130 and forms a fluid-tight seal between the lid 110 and the rim 122 of the cooking vessel 120. In a second configuration, the latching arrangements 200 are moved to the fully unlatched position (FIGS. 3A-C, and 4A-4B) allowing the lid 110 to be completely removed from the cooking vessel 120 and housing 130 for adding or removing food contents.

In an embodiment, a power cord 134 may be connected to the electronic controls 142, 144 and the heating element (not shown). A plug 136 may be provided at one end for connecting the power cord 134 to a conventional source of electrical power including but not limited to household 120vac. A pair of cord wraps 132 (only one shown in FIG. 2) may be disposed on the rear side of the housing 130 for storing the electrical cord 134.

Referring now also to FIGS. 3A-3C in addition to FIGS. 1-2, each latching arrangement 200 includes a lid mount 202 mounted on opposing sides of the lid 110. It should be appreciated that the opposing latching arrangements 200 are mounted oppositely on the lid 110 and housing 130 to ensure a good seal between the lid 110 and the cooking vessel 120 around the entire periphery of the lid 110 and cooking vessel 120. Each lid mount 202 may be secured to the lid 110 with a fastener 204 which may be a rivet, screw, nut and bolt, or other suitable fastener. A U-shaped member 208 is pivotally attached to a hinge 206 formed in the lid mount 202 by curved ends 212 of each U-shaped member 208 being inserted into holes (not shown) on opposing sides of the hinge 206. The U-shaped member 208 may be a wire of suitable diameter. For example, the diameter of the wire comprising the U-shaped member 208 may be three millimeters (3.0 mm). The U-shaped member 208 may be rotated into a recess 201 in the lid mount 202 for, storage secured therein by a detent 203 on opposing sidewalls of the recess 201 (only one shown in FIG. 3A). Each latching arrangement 200 includes a rotating member 220 with a lever 222 that is rotatably connected to a housing mount 230 disposed on the sidewall 131 of the housing 130. The rotating member 220 is rotatably connected to the housing mount 230 by a spindle 221 that fits into a bore 236 in the housing mount 230. A well 232 in the housing mount 220 receives the body of the rotating member 220.

In another embodiment, there may be any number of latching arrangements disposed on the periphery of the lid 110 for securing the lid 110 and cooking vessel 120 to the housing 130. For example, there may be a single latching arrangement 200, three latching arrangements 200, or four latching arrangements 200, etc., disposed evenly spaced about the periphery of the lid 110 for securing the lid 110 and cooking vessel 120 to the housing. It should be understood that this is not meant to be limiting as there may be any other number of latching arrangements disposed on the periphery of the lid 110 for securing the lid 110 and cooking vessel 120 to the housing 130.

Prior to the lid 110 being placed onto the cooking vessel 120, the rotating members 220 are rotated such that the levers 222 are in the fully upright position (unlatched or second configuration). A detent 2206 on the interior of the rotating member 220 engages a projection 234 on the interior of the housing mount 230 to lock the lever 222 of the rotating member 220 in the upright position (unlatched or second configuration). The lid 110 is then placed onto the cooking vessel 120 disposed in the housing 130 and the U-shaped member 208 is pivoted around the rotating member 22Q such that an end 210 of the U-shaped member 208 is looped around a cammed slit-tape 224 on the bottom of the rotating member 220. The levers 222 may be depressed such that the rotating members 220 are rotated in either the clockwise or counter-clockwise directions (represented by arrows CW and CCW in FIG. 2) a maximum of ninety-degrees until one of a plurality of stops 227 (best seen in FIG. 3C) radially disposed on the interior of the rotating member 220 is engaged by the projection 234. The stops 227 ensure that the rotating member 220 is only rotated a maximum of ninety-degrees in either direction and signifies when the rotating member 220 is in the rotated position (latched or first configuration).

While the rotating members 220 are rotated in either of the clockwise (represented by arrow CW in FIG. 2) or counter-clockwise (represented by arrow CCW in FIG. 2) directions, the offset caromed surface 224 on the bottom of the rotating member 220 urges against the ends 210 of the U-shaped members 208 such that a downward force is transmitted through the U-shaped members 208 to the lid mounts 202. This downward force urges the lid 110 downward on opposing sides while compressing the gasket 112 and securing the lid 110 to the cooking vessel 120 and the housing 130.

This process is reversed to remove the lid 110 from the cooking vessel 120 and the housing 130. The lever 222 is rotated upward to the upright position (unlatched or second configuration) until the projection 234 engages the detent 226 that holds the rotating member 220 in the upright position (unlatched or second configuration).

The various steps of the process of securing the lid 110 to the cooking vessel 120 and housing 130 utilizing the latching arrangements 200 are seen in FIGS. 4A-D. Illustrated in FIG. 4A, the latching arrangements 200 are unlatched where the lid 110 may be removed from the cooking vessel 120 and housing 130. The levers 222 are in the fully upright position and the rotating members 220 are in the unlatched or second configuration. Illustrated in FIG. 4B, the latching arrangements 200 are in a first intermediate position where the U-shaped members 208 are pivoted or looped around the rotating members 220. Illustrated in FIG. 4C, the latching arrangements 200 are in a second intermediate position where the U-shaped members 208 are pivoted onto the rotating members 220 before the rotating members 220 are rotated to one of the two secured positions (latched or first configuration). Illustrated in FIG. 4D, the latching arrangements are in a fully latched position or first configuration where the rotating member 220 is fully rotated ninety-degrees in either of the clockwise (represented by arrow CW in FIG. 2) or counter-clockwise (represented by arrow CCW in FIG. 2) directions and the projection 234 engages one of the stops 227 (FIG. 3C) for preventing further rotation of the rotating member 220.

It will be appreciated by person's skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A cooking appliance, comprising:
a container including an interior volume and an opening into the interior volume wherein food contents to be heated is accessed, the container including a rim defining the opening;
a housing having a recess for receiving the container;
a heating element proximate the recess for heating the container when seated in the recess;
a lid sized and shaped to fit over the opening and having a periphery that is seated on the rim when the lid is placed over the opening of the container; and
at least one latching arrangement disposed on the periphery of the lid configured to secure the lid to the container and the housing when the container is seated in the recess, the latching arrangement including:
a lid mount mounted on the periphery of the lid;
a U-shaped member pivotally attached to the lid mount; and
a rotating member mounted on the housing and rotatable clockwise or counter-clockwise between an unlatched position and one of two latched positions;
wherein an end of the U-shaped member is looped around the rotating member when the rotating member is in the unlatched position, and as the rotating member is rotated in either of the clockwise or counter-clockwise directions to one of the latched positions, a cammed surface of the rotating member urges against the end of the U-shaped member which creates a force in the U-shaped member that is transmitted to the lid mount on the lid causing the lid mount to urge the lid against the rim of the container and secure the lid to the container and the housing.

2. The cooking appliance of claim 1, wherein the at least one latching arrangement is two latching arrangements disposed oppositely on the periphery of the lid configured to secure the lid to the container and the housing in a fluid-tight manner.

3. The cooking appliance of claim 1, further including a lever extending from the rotating member which is depressed to rotate the rotating member in either of clockwise or counter-clockwise directions between the unlatched position and one of the two latched positions.

4. The cooking appliance of claim 3, wherein the lever is in an upright position when the rotating member is in the unlatched position.

5. The cooking appliance of claim 1, wherein the rotating member is rotated a maximum of ninety-degrees in the clockwise or counter-clockwise directions from the unlatched position to the one of two latched positions.

6. The cooking appliance of claim 5, further including a housing mount on a sidewall of the housing wherein the rotating member is rotatably mounted, the rotating member further including a spindle that fits into a bore formed in the housing mount.

7. The cooking appliance of claim 6, further including a projection extending from the housing mount, and a detent on the rotating member configured to engage the projection and lock the rotating member in the unlatched position.

8. The cooking appliance of claim 6, further including a projection extending from the housing mount, and a pair of stops on the rotating member configured to engage the projection when the rotating member is rotated the maximum of ninety-degrees in either of the clockwise and counter-clockwise directions to one of the two latched positions.

9. The cooking appliance of claim 1, wherein the U-shaped member is a formed from wire of a three-millimeter diameter.

10. The cooking appliance of claim 1, wherein the container is formed from a ceramic material.

11. A slow cooker appliance, comprising:
a lid having a periphery;
a cooking vessel having an opening wherein food contents to be heated is inserted and a rim wherein the periphery of the lid is seated when the lid is placed over the opening of the cooking vessel;
a housing having a recess for receiving the cooking vessel;
a pair of opposing latching arrangements disposed about a periphery of the lid for securing the lid to the cooking vessel and the housing when the cooking vessel is seated in the recess, each latching arrangement including:
a lid mount mounted on opposing sides on the periphery of the lid;
a U-shaped member pivotally attached to the lid mount; and
a rotating member rotatably connected to a housing mount disposed on a sidewall of the housing and rotatable clockwise or counter-clockwise between an unlatched position and a latched position;
wherein the U-shaped member is pivoted such that an end of the U-shaped member is looped around the rotating member when the rotating member is in the unlatched position, and as the rotating member is rotated in either of the clockwise or counter-clockwise directions to the latched position, a cammed surface of the rotating member urges against the end of the U-shaped member which creates a force in the U-shaped member that is transmitted to the lid mount on the lid causing the lid mount to urge the lid against the rim of the cooking vessel and secure the lid and the cooking vessel to the housing.

12. The slow cooker appliance of claim 11, further including a lever extending from the rotating member which is depressed to rotate the rotating member in either of clockwise or counter-clockwise directions between the unlatched position and one of the two latched positions.

13. The slow cooker appliance of claim 12, wherein the lever is in an upright position when the rotating member is in the unlatched position.

14. The slow cooker appliance of claim 11, wherein the rotating member is rotated a maximum of ninety-degrees in the clockwise or counter-clockwise directions from the unlatched position to the one of two latched positions.

15. The slow cooker appliance of claim 14, further including a housing mount on a sidewall of the housing wherein the rotating member is rotatably mounted, the rotating member further including a spindle that fits into a socket formed in the housing mount.

16. The slow cooker appliance of claim 15, further including a projection extending from the housing mount, and as detent on the rotating member configured to engage the projection and lock the rotating member in the unlatched position.

17. The slow cooker appliance of claim 15, further including a projection extending from the housing mount, and a pair of stops on the rotating member configured to engage the projection when the rotating member is rotated the maximum of ninety-degrees in either of the clockwise and counter-clockwise directions to one of the two latched positions.

18. The slow cooker appliance of claim 11, wherein the U-shaped member is a formed from wire of a three-millimeter diameter.

19. The slow cooker appliance of claim 11, wherein the cooking vessel is formed from a ceramic material.

20. The slow cooker appliance of claim 11, further including a gasket around the periphery of the lid and seated between the lid and the rim of the cooking vessel.
